(19) United States
(12) Patent Application Publication
(10) Pub. No.: US 2026/0157338 A1
(43) Pub. Date: Jun. 11, 2026

(54) MULTI-LAYER CAT LITTER BOX

(71) Applicant: MR. CATMAN INC., Spring, TX (US)

(72) Inventors: Zhuangzi Li, Spring, TX (US); Franklin Mark Schellenberg, Palo Alto, CA (US)

(73) Assignee: MR. CATMAN INC., Spring, TX (US)

(21) Appl. No.: 19/014,176

(22) Filed: Jan. 8, 2025

Related U.S. Application Data
(60) Provisional application No. 63/730,642, filed on Dec. 11, 2024.

(51) Int. Cl. A01K 1/01

(52) U.S. Cl. CPC A01K 1/0114

(57) ABSTRACT

A multi-layered sifting cat litter box with an integrated waste storage compartment, designed for use with wood pellet litters. The multi-layer cat litter box comprises an upper bin for cat urination and defecation, the upper bin having a bottom with a portion comprising a plurality of apertures smaller than wood pellet litter dimensions, and also a second bin having a solid bottom and sides, wherein a top portion of the second bin also comprises a support section that allow the upper bin to be supported on the support section of the second bin. The multi-layered litter box may additionally comprise a lower pan having a raised edge for placement beneath the second bin and protection of the floor. The system effectively separates waste from unsoiled litter, provides storage for sawdust and feces, and manages odors by enveloping feces in sawdust.

### CROSS-REFERENCE TO RELATED APPLICATIONS

This Patent Application claims the benefit of U.S. Provisional Ser. No. 63/730,642 , filed on Dec. 11, 2024, and titled MULTI-LAYER CAT LITTER BOX, which is incorporated herein by reference in its entirety.

### FIELD OF THE INVENTION

The present invention pertains to a cat litter box system specifically designed for use with wood pellet litters, such as pine or other wood-based litters. Some embodiments feature an optional mesh insert, allowing compatibility with various types of litter and not solely wood pellet litter.

### BACKGROUND

Cats use litter boxes as their designated area for defecating and urinating. These boxes require the use of litter, which serves as bedding for cats to relieve themselves on. After a cat uses the litter box, feces come into contact with the litter, which absorb moisture and harden. The user can then clean the box by removing the solid waste and any soiled litter attached to it, usually with a specially designed sifter to pick up cat waste while leaving the litter behind.

There are various types of litter available. One common type of cat litter is pellet litter, which often includes materials such as wood, sawdust, paper, corn, tofu (bean curds), wheat, walnut shells, grass, straw, or coconut husks. For simplicity, these pellet-based litters will be collectively referred to as “wood pellet litter” or simply “pellet litter” throughout this document.

Wood pellet litter, illustrated in the photograph of FIG. 1, is created by compressing wood fibers—typically from sawdust or wood byproducts—under heat and pressure to form absorbent, eco-friendly pellets. International Standards Organization (ISO) publishes standard ISO 17225-2 governing graded pellets for household and commercial applications and for industrial use. The standard specifies diameters between 6 and 8 mm, with most commercial pellets having a length ranging from 10 mm to 30 mm. Although the standard was originally created for wood pellets used for interior heating, the same standard applies to pellets repurposed for other uses such as cat litter.

Wood pellets offer numerous advantages, including:
Excellent absorbency and odor control: The porous structure of wood pellets allows them to absorb significant amounts of moisture, while the natural fibers expand, breaking down to increase surface area for better odor control.
Low tracking: Due to their larger size (typically 10-15 mm in length, but in some cases up to 30 mm in length, compared to 0.5-2.0 mm dimensions for traditional clay litter), wood pellets are less likely to stick to a cat's paws and be tracked outside the box. Even when they do escape the box, their size makes them easy to collect and return.
Eco-friendliness: Wood pellets are biodegradable, made from renewable materials, and generate less dust compared to traditional clay litters. They are also lightweight and often more affordable.

However, cleaning wood pellet litter presents certain challenges. When exposed to liquid (such as cat urine), the pellets break down into sawdust, which mixes with unused pellets, making it difficult to separate the two. An example of wood pellet cat litter is shown on the left in FIG. 2, and the sawdust that results after breaking down under exposure to cat urine is shown on the right in FIG. 2.

Cleaning typically involves two steps:
(1) removing solid waste along with any soiled pellets, and
(2) removing the decomposed sawdust.

This latter step is a health matter, if not promptly addressed, the fine sawdust particles can easily be tracked out of the box and create additional mess and contamination of a household.

Several popular sifting litter boxes are currently on the market. However, existing sifting litter boxes share a common drawback: they require frequent cleaning, particularly the removal of sawdust after nearly every use, and they have no convenient space for sawdust storage.

There is therefore a need for a cat litter box for use with wood pellet litter that provides second storage compartment for sawdust collection and storage as part of the litter box system.

### BRIEF SUMMARY

The present invention addresses this challenge by providing an integrated sifting system that includes a dedicated storage compartment for both sawdust and waste. This is achieved using a multi-layered cat litter box system, in which an upper bin accessible for the cat to enter to urinate and defecate is positioned over a second storage container for sawdust and waste.

The disclosed litter box assembly is specifically designed for use with wood pellet litters. In addition to the bin for use by the cat and the storage container below, the system may also include an optional lower tray upon which the system rests, and on which the upper bin can be placed while the container is emptied, protecting the floor from additional sawdust and particles from falling on the floor. This design leverages the ability of sawdust to envelop waste, effectively containing odors and improving overall cleanliness.

With this system, daily waste disposal is no longer necessary as long as odor control is maintained. This feature is particularly convenient for areas where garbage collection occurs only once a week. Cat feces and sawdust can be stored in the storage container and disposed of just before the scheduled garbage pickup. The fine sawdust particles encapsulate the cat feces, offering effective odor control and making litter box maintenance easier and less burdensome.

### BRIEF DESCRIPTION OF THE DRAWINGS

FIG. 1 shows a photograph of various cat liter pellets.

FIG. 2 show a photograph of cat litter pellets on the left, and sawdust formed from cat litter pellets on the right.

FIG. 3 illustrates an embodiment of a multi-layer cat litter box having an upper bin, a second (middle) container bin, and an (optional) lower pan.

FIG. 4A illustrates a perspective view of an upper bin having integrated apertures for an embodiment of the invention.

FIG. 4B illustrates a top view of the upper bin of FIG. 4A.

FIG. 5A illustrates a perspective view of an upper bin for use with a detachable mesh comprising apertures for an embodiment of the invention.

FIG. 5B illustrates a perspective view of a detachable mesh comprising apertures for use with the upper bin of FIG. 5A.

FIG. 6 illustrates fasteners and corresponding holes for fasteners in a detachable mesh as used in some embodiments of the invention.

FIG. 7 illustrates a second container bin as used in some embodiments of the invention.

FIG. 8 illustrates a lower pan as used in some embodiments of the invention.

FIG. 9 illustrates a flow chart for a method for assembling a multi-layer cat litter box as disclosed.

FIG. 10 illustrates a perspective view of an assembled multi-layer cat litter box according to an embodiment of the invention, having an upper bin, a second (middle) container bin, and a lower tray.

FIG. 11A illustrates a side view of the assembled cat litter box of FIG. 9.

FIG. 11B illustrates a rear view of the assembled cat litter box of FIG. 9.

FIG. 12 shows a photograph of an assembled multi-layer cat litter box according to an embodiment of the invention.

FIG. 13 illustrates a mesh designed to fit directly in an upper bin for an embodiment of the invention.

FIG. 14 illustrates perspective view of a multi-layer cat litter box with an additional cover.

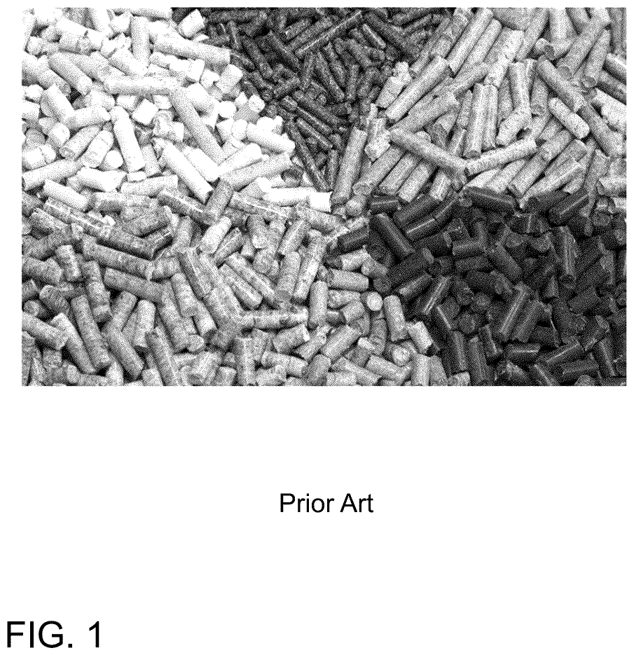

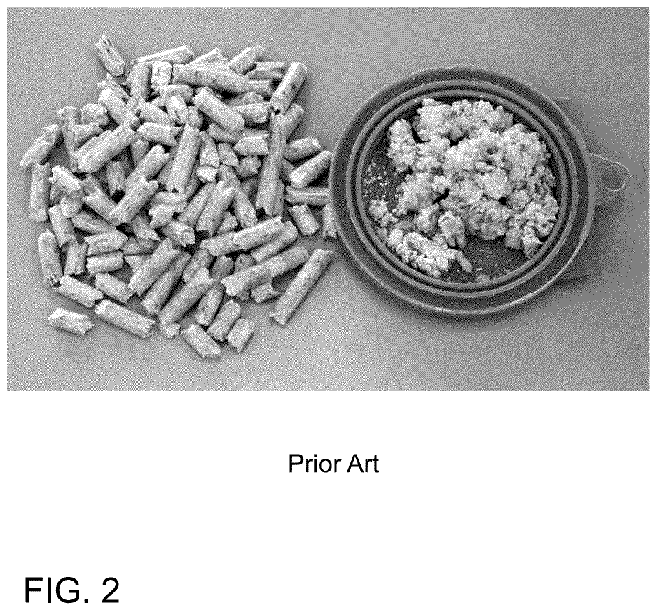

### DETAILED DESCRIPTION

### I. Multi-Tiered Litter Box Components

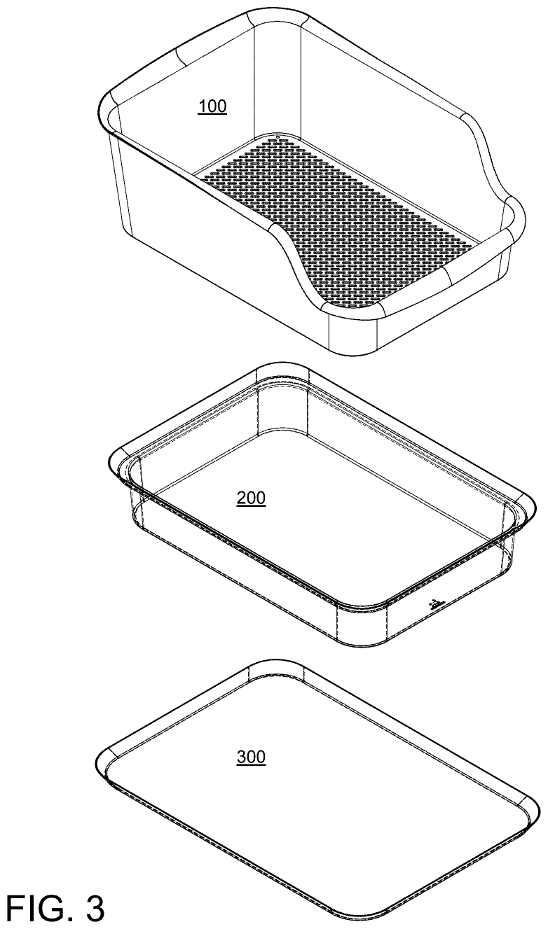

The multi-layer cat litter box system disclosed herein comprises two primary components, illustrated in FIG. 3. The first component is an upper bin 100, where wood pellet cat litter may be placed and which the cat enters to urinate and defecate. This upper bin 100 may also be known as a top pan, a sifting pan, a sifting tray, a sifting box or simply a sifter.

The second component is a second bin 200 for storage of sawdust and feces and which supports the upper bin. This second bin 200 may also be referred to as a container, a storage bin, a storage pan, a middle pan, a storage tray or simply the catcher.

Also shown in FIG. 3 is an optional lower pan 300 upon which the multi-layer cat litter box can rest. The lower pan 300 can also be used for temporary placement of the upper bin when the second container is being emptied, protecting the carpet from any sawdust that might fall out of the upper pan when no longer supported by the second bin. This lower pan may also be referred to as a lower bin, a base pan, a support tray, or a carpet protector.

The size and shape of these pans can vary depending on specific usage scenarios. While most of litter boxes are elongated rounded rectangles or oval in shape, some have the shapes of square or triangle to accommodate different needs. For simplicity, a rectangular box with rounded corners will be used for non-limiting illustrative purposes throughout this disclosure.

In some embodiments, the rounded rectangular shape of the upper bin 100 will have its longest dimension smaller than 60 cm, while the sides of the of the second bin have a height greater than 2.5 cm, and the sides of the upper bin will have a height greater than the height of the second bin. In some embodiments, the sides of the upper bin comprise two portions, a back portion and a front portion, with the height of the back portion taller than the front portion.

### Upper Bin

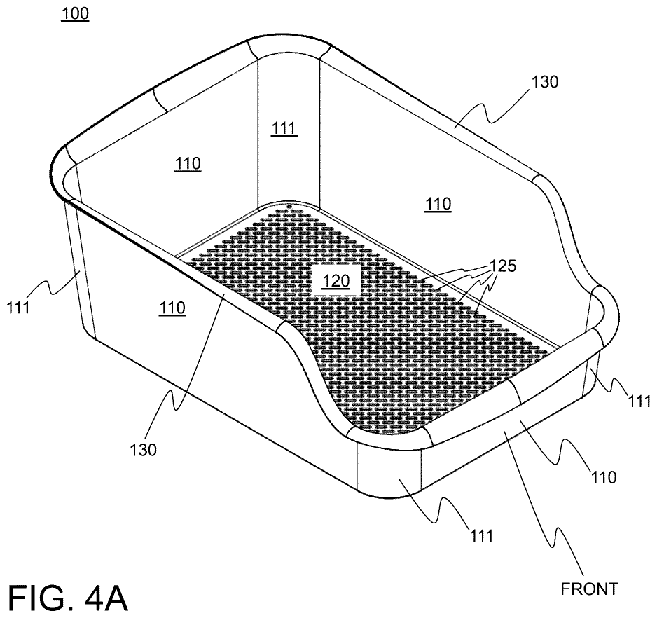

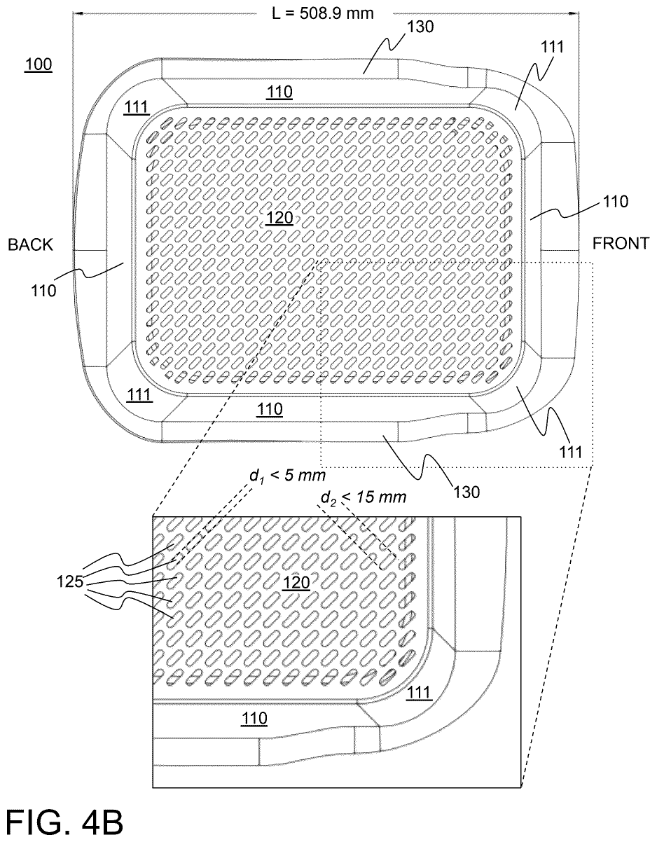

An example of an upper bin 100 is illustrated in FIGS. 4A and 4B. The illustrated embodiment comprises a plurality of sides 110 and rounded corners 111
(in the non-limiting example FIG. 4B, forming an approximately rounded rectangular form with a longest dimension of approximately 500 mm) and features a bottom 120 with a plurality of apertures 125 (which may also be called holes or slats) that allow sawdust to pass through while retaining unsoiled pellets and cat feces. As wood pellets absorb cat urine, they break down into sawdust, which falls through the apertures, while the pellets and waste remain above.

The size and shape of the apertures may be selected based on the size and shape of the wood pellets. Generally, apertures should not be larger than the size of a typical wood pellet to ensure the pellets are retained while allowing sawdust to pass through. However, apertures that are too small may cause sawdust to clog the openings. Because wood pellets are typically cylindrical with a diameter greater than 5 mm and a length of 10-30 mm, using apertures sized with a minimum dimension 5 mm or smaller and with a longer dimension at least 5 mm but shorter than the average length of the wood pellets can prevent uncontaminated wood pellets from falling into the second bin 200, while allowing sawdust to enter easily.

It should be noted that, while the descriptions and embodiments disclosed herein are generally for use with pellets conforming to the ISO 17225-2 standard, some cat owners may select to use other, larger pellets as cat litter if commercially offered. When selecting to use larger pellets, embodiments of the disclosed multi-layer cat litter box can be implemented using an upper bin with appropriately larger apertures, as long the smallest dimension of the apertures is still smaller than the smallest dimension specified for the pre-selected pellet litter being used.

The illustrations in this disclosure generally present apertures 125 as having a rounded rectangular shape, with length being approximately three times the width. In the illustration of FIG. 4B, the enlarged insert illustrates apertures of the upper bin having rounded rectangular shapes, with a first dimension being smaller than 5 mm and a second dimension perpendicular to the first dimension being greater than the first dimension and smaller than 30 mm. For an upper bin molded as a single piece of plastic, apertures with rounded corners may provide better longevity, as sharp 90° corners are more prone to stress and therefore more likely to form cracks and fracture. However, round circular holes, square holes, triangular holes, or any other shape may be used, as long as the smallest dimension of the apertures 125 is smaller than the diameter of the wood pellets being used.

In some embodiments, the sides and the bottom of the upper bin are molded from plastic as a single contiguous structure. In some embodiments, upper bin may be fabricated from metal or stainless steel. In some embodiments, the upper bin may have sides and bottom fabricated from different materials.

FIG. 4A as illustrated also shows the height of the front portion of the upper bin is less than half the height of the back portion of the upper bin. This design allows easy access through the front for a cat to enter or leave the litter box, while discouraging access through the other sides.

FIGS. 4A and 4B as illustrated also show rolled-over portions 130 or lips at the top of some of the sides of the upper bin, allowing a surface for lifting the upper bin using fingertips. These rolled-over portions may vary in dimension around the top of the upper bin, and may or may not be present in some embodiments.

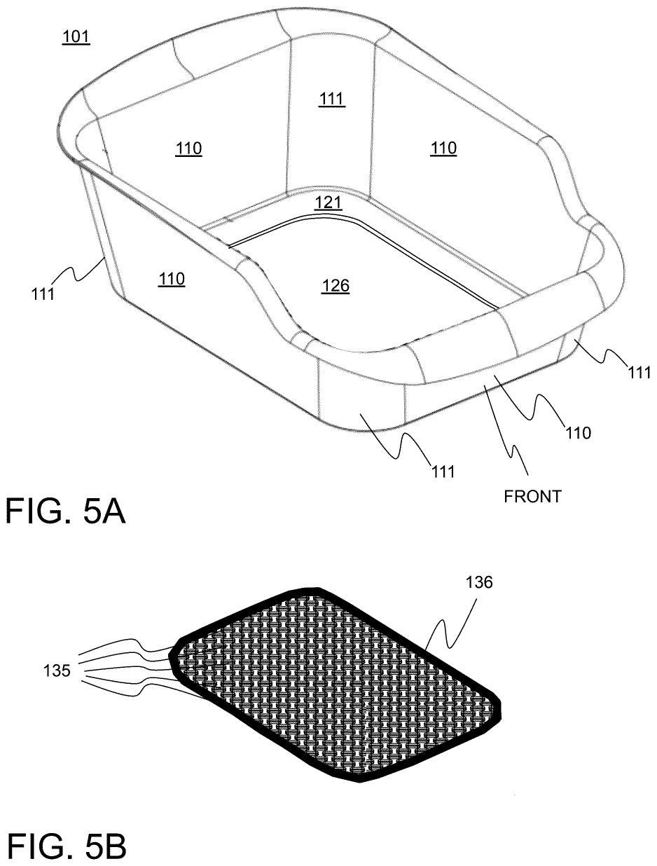

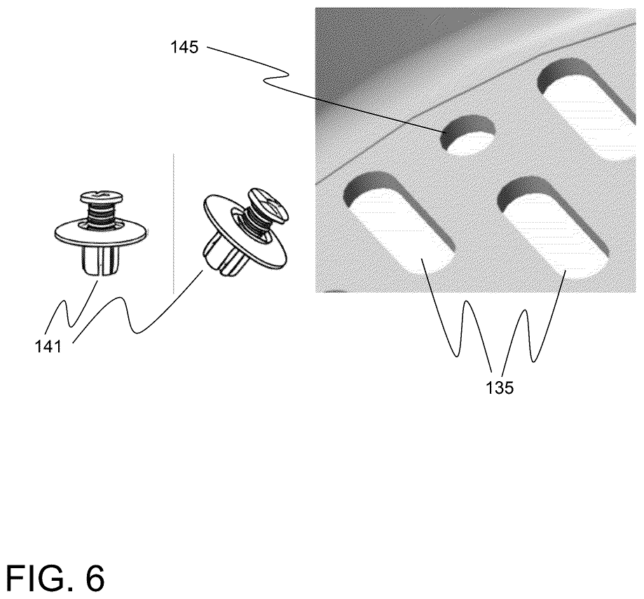

FIGS. 5A, 5B, and 6 illustrate another embodiment for the upper bin 101, in which the portion of the upper bin 101 comprising apertures 135 is detachable. The apertures 135 may be provided in a screen 136 or mesh that can be removed from the bottom of the upper bin 101. The upper bin 101 in this case may be provided with a large, single aperture or opening 126 with a shelf 121 at the edge, on which the screen 136 can rest. In some embodiments, as illustrated in FIG. 6, fasteners 141 may be provided that allow attachment to the upper bin through specially placed apertures 145 in the screen 136 and similarly positioned slots in the shelf 121 of the upper bin, allowing the screen 136 to be securely placed and attached, yet still be detachable.

In some embodiments, the mesh or screen 136 may be fabricated from molded plastic. In some embodiments, the mesh or screen 136 may be fabricated from stainless steel. In some embodiments, the detachable portion of the bottom of the upper bin 101 additionally comprises one or more sides having a height dimension less than a height dimension of the sides 110 of the upper bin 101, and typically less than the height dimension of the front of the upper bin 101.

### Second Bin

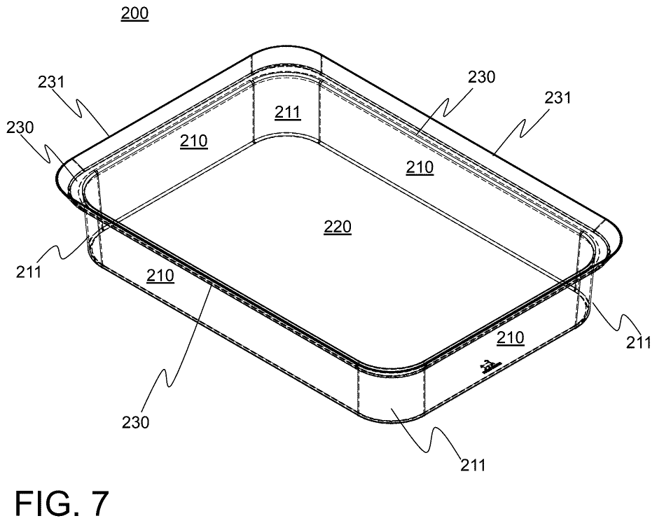

The second bin 200, illustrated in FIG. 7 as illustrated comprises a plurality of sides 210 and rounded corners 211 (in this example, forming a rounded rectangular form) and features a solid bottom 220 with no apertures. The top portion of the sides 210 and corners 211 of the second bin also may, in some embodiments, comprise one or more sections having widths that allow the upper bin to be supported by those sections. Those sections may be simply the tops of the sides, designed to be suitably wide enough to provide support for the upper bin, or be specially designed lip sections at the top of the upper bin. In the illustration of FIG. 7, these upper sections are in the form of a lip comprising a shelf 230 and a raised edge 231 or rim, allowing the upper bin 100 to be supported on the shelf 230 of the second bin while allowing position of the upper bin to be restrained from moving by the raised edge 231.

Second bin 200 serves as a storage compartment for sawdust and waste. Sawdust generated by the interaction between cat urine and wood pellets will directly fall under gravity through the apertures 125 of the upper bin into the second bin 200, while users can either scoop and discard cat feces directly or transfer them into the second bin 200 to be stored along with the sawdust until a more thorough cleaning is carried out.

If moved from the upper bin 100 into the second bin 200 with the sawdust for storage, the feces become enveloped, helping to trap odors and minimize unpleasant smells. For added convenience, users can line the second bin 200 with a waste bag, enabling easier disposal. When it's time to clean, the user simply lifts the upper sifting bin 100 and removes the bag with all the waste inside.

The depth of the second bin 200 should be selected to allow for storage of sawdust and feces for possibly several days. Although a second bin depth as small as
1 cm may be possible, embodiments with a minimum depth of 2.5 cm are typically preferred for storing several days of sawdust and feces when used by one cat. In North American homes, aligning with the weekly garbage collection schedule, at least one week of sawdust storage is preferred, which might be better achieved with a minimum depth of 8.0 cm for the second bin.

In some embodiments, the sides and the bottom of the second bin 200 are molded from plastic as a single contiguous structure. In some embodiments, the second bin 200 may be fabricated from metal or stainless steel.

### Lower Pan

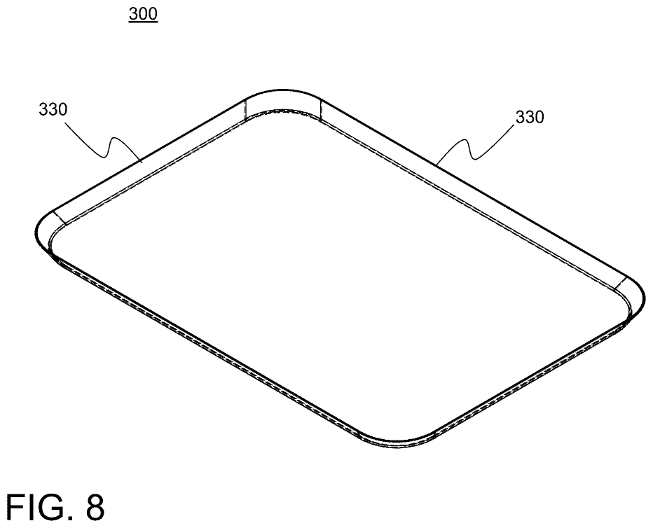

In some embodiments, a lower pan 300 may also be used. An example of a lower pan 300 is illustrated in FIG. 8. In some embodiments, such as that shown in FIG. 8, the lower pan 300 comprises a raised edge 330 or rim that allows position of the second bin to be restrained when placed in the lower pan. The optional lower pan 300 is placed on the floor and serves as a base supporting the second bin 200 and the upper bin 100 above it. The lower pan 300 can help prevent sawdust from falling onto the floor during the cleaning process, and can also serve as a temporary holding platform for the upper bin when the second bin being emptied.

The lower pan 300 may be reversible and can be inverted to function as a step or stool for cats entering or exiting the litter box. The lower pan 300 may also serve as a mat to collect litter tracked outside the box. This design ensures stability, cleanliness, and ease of use for the entire system.

In some embodiments, the lower pan 300 is molded from plastic as a single contiguous structure. In some embodiments, the lower pan 300 may be fabricated from metal or stainless steel.

### II. Multi-tiered Litter Box Assembly

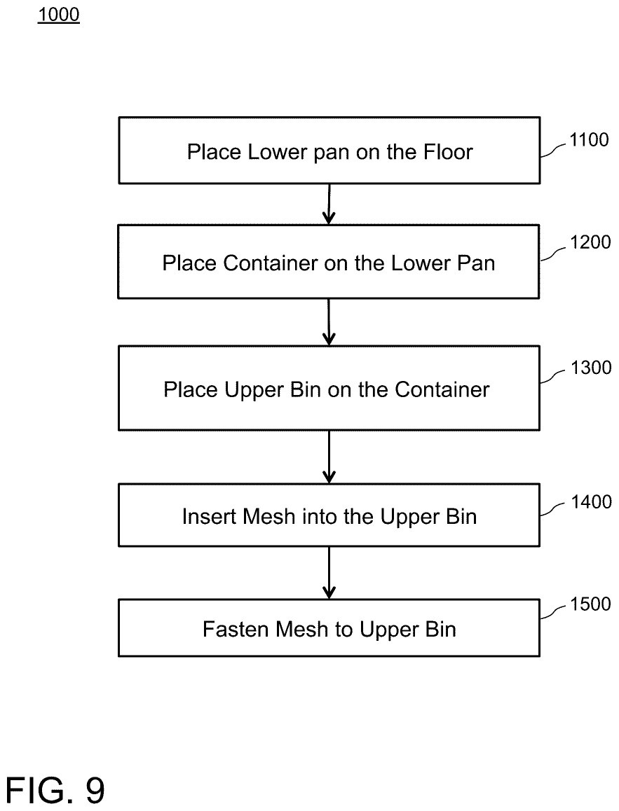

The operations for assembling a multi-tiered cat litter box according to the disclosed invention may be summarized in the process 1000 illustrated in the flow chart of FIG. 9, and are discussed in more detail below. The flow chart represents a process assembling a three-tier litter box, such as one with an upper bin 101 having a detachable portion 136 comprising apertures 135 or a mesh, a second bin 200, and lower pan 300. Other assembly processes may be used.

In the initial operation 1100, a tray is placed on the floor. This tray is may be the lower pan 300, as described above and illustrated, for example, in FIG. 8, with a flat surface and a raised edge 330.

In the next operation 1200, a container for sawdust and cat waste is placed on the tray. This container may be the second bin 200 as described above and illustrated in FIG. 7, having a bottom 220 with no apertures and having a plurality of sides 210, with the top portion of the sides of the second bin 200 comprising a lip having a shelf 230 and a raised edge 231.

In the next operation 1300, an upper bin 100 is placed on the shelf 230 of the container (i.e. the second bin 200) such that the upper bin 100 is restrained in lateral motion by the raised edge 231 when placed on the shelf 230 of the container (i.e. the second bin 200). The upper bin 101 may have a plurality of sides 110 and a bottom shelf 121 with at least one large opening 126, such as the upper bin 101 illustrated in FIG. 5A.

In the next operation 1400, a mesh insert 136 as illustrated in FIG. 5B is placed within the upper bin 100 such that the mesh insert 136 covers the at least one opening 126 of the upper bin 101. The mesh 136 may comprise a plurality of apertures 135, each aperture having its smallest dimension being less than 5 mm. In some embodiments, the apertures in the mesh may have a smallest dimension being less than 1 mm.

In the next operation 1500, the mesh insert 136 is fastened to the shelf 121 of the upper bin 101 such that the mesh insert 136 covers the at least one opening 126 of the upper bin 101.

The assembly process above describes using a lower pan and an upper bin with a detachable portion comprising apertures or a mesh. For embodiments without using these components, operation 1100 can be skipped by placing the second bin directly on the floor, and the assembly is complete at operation 1300, since, if a detachable mesh is not used, the upper bin will comprise apertures as illustrated in FIGS. 4A and 4B, so operations attaching a mesh screen are not necessary.

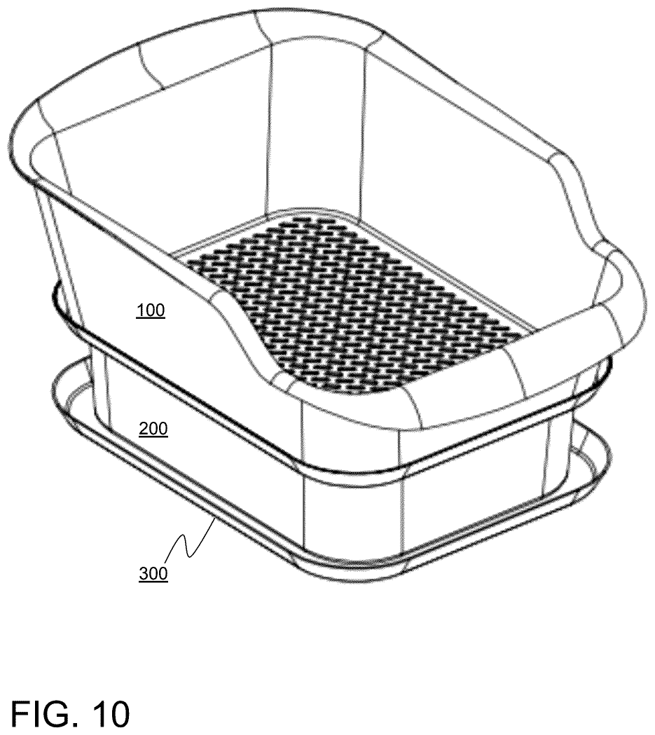

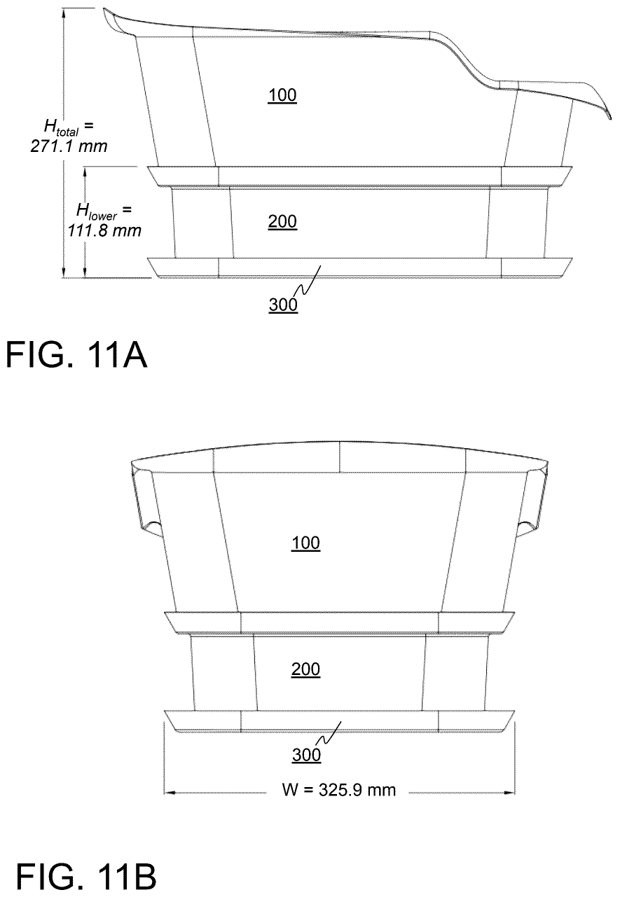

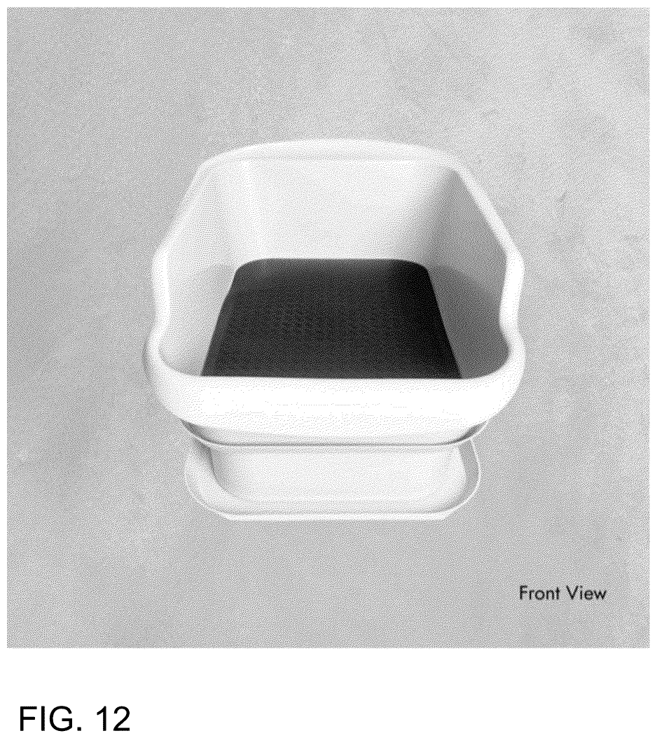

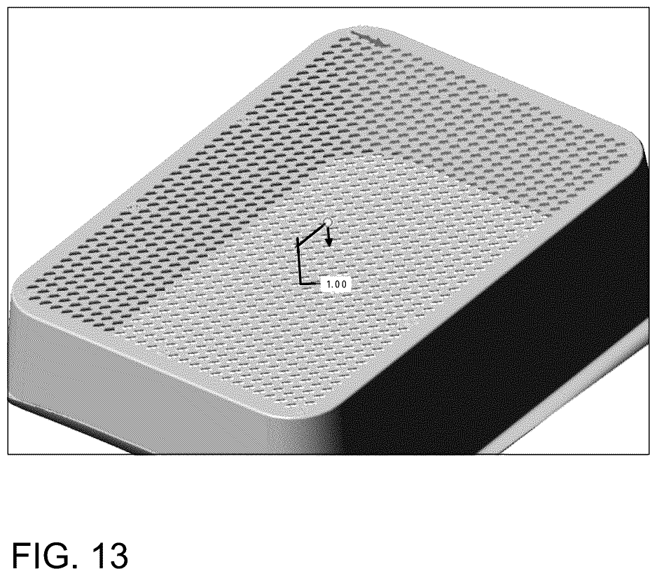

The litter box is now assembled, and ready to have litter pellets placed into the upper bin, supported by the mesh comprising apertures. A perspective view of an assembled multi-layer litter box according to an embodiment is shown in FIG. 10, with side views and back views illustrated in FIGS. 11A and 11B respectively. Some non-limiting exemplary dimensions are also illustrated in FIGS. 11A and 11B. A photograph of an assembled multi-layer cat litter box according to an embodiment is shown in FIG. 12.

After the upper bin is filled with wood pellets, once a cat urinates into the litter pellets, the pellets dissolve into sawdust and the sawdust falls through the apertures of the upper bin into the container, or second bin. The sawdust can then be stored in the container, accumulating over several days, until the litter box is disassembled and the container emptied. The litter box may then be reassembled according to some variation of the process described above.

### III. Mesh Insert

The descriptions provided above included use of a detachable portion of the upper bin that may comprise apertures in the form of a mesh insert. Such a mesh insert is an additional, optional component made of plastic, metal, or other suitable materials, with apertures ranging in size from 0.5 mm to 15 mm. Such a mesh can be used as a detachable insert for apertures for the upper bin, allowing for a variety of aperture sizes to be used when fitted into the upper bin.

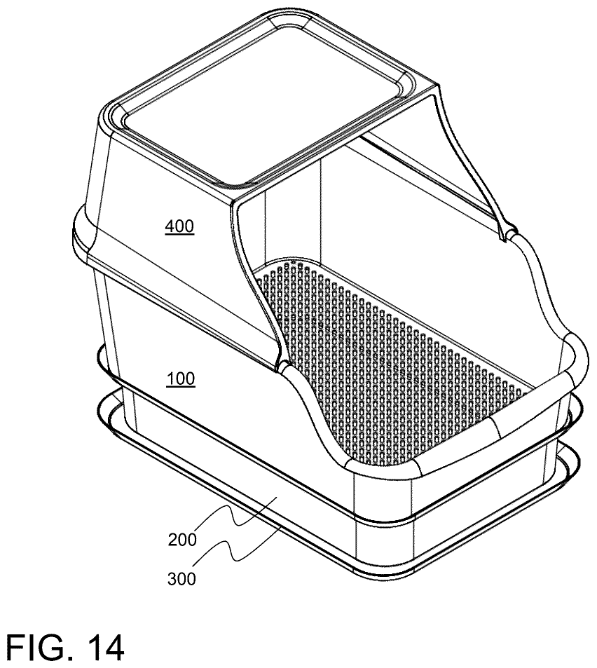

A similar mesh insert, such as that illustrated in FIG. 13, may also be placed between the upper bin and second bin. Such a mesh may be designed to accommodate various types of litter beyond wood pellets.

Such a mesh insert serves several key functions.

Dust Filtration: The mesh can feature very small holes (e.g., 0.5 mm) to filter out dust, which is a common byproduct of many types of litter. As clay litter particles are typically 1-3 mm in size, this feature effectively traps dust, creating a cleaner and safer environment for pets. Dust filtration is a health matter, as excessive dust can be harmful to both pets and their owners.

Transition Support for Different Litter Types: such a mesh insert is particularly useful during the transition from traditional clay litter (1-3 mm) to pellet litter (5-30 mm). By allowing a mixture of both types of litter during the transition period, the mesh ensures a smooth shift, helping cats adjust with minimal disruption. Over time, the proportion of pellets can be increased while the mesh maintains the effectiveness of the system.

Protective Layer: such a mesh insert, when used in the upper bin, can also serve as a protective layer for the upper bin, preventing scratches and wear caused by scooping over time. A durable mesh insert, particularly one made from stainless steel, can extend the life of the upper bin. Additionally, stainless steel offers odor control properties, which further enhance the overall effectiveness of the litter box system.

The mesh insert can also be securely attached to the upper bin using fasteners or screws, as was illustrated in FIG. 6. Appropriately sized holes may be created to accommodate such fasteners, and once inserted, the self-locking fasteners or screws provide strong support, ensuring the mesh insert stays firmly in place and prevents any movement. Some or all of the holes can be concealed within the slats, or the slats themselves can serve as the fastening points, contributing to a clean, streamlined appearance. Other keyed approaches to attaching a mesh to one of more pans, such as interlocking tongue-and groove designs, may be used as well.

If the mesh is made from a rigid material, such as stainless steel, fasteners or screws may not be necessary. When the mesh insert is precisely shaped to fit the bottom of the upper bin, it can sit securely in place without any movement on its own.

The upper bin, second bin, lower pan, and mesh insert are typically made from plastic materials, such as polypropylene (PP) or polyethylene terephthalate (PET or PETE), due to their durability and cost-effectiveness. However, stainless steel can also be used, particularly for its superior odor control properties. Both plastic and metal components can be manufactured using a range of modern machining techniques. For metal parts, such techniques include CNC cutting, metal molding, laser cutting, water jet cutting, and etching etc. Plastic parts are commonly produced through processes like injection molding, thermoforming, laser cutting, CNC machining, and punching or stamping etc.

### IV. Additional Options

Several additional options can be used with the multi-layer cat litter box assembly as described above. These may be optional attachments to the structures already disclosed, and are presented in the following section.

### Hood or Cover

An optional hood or cover, as illustrated in FIG. 12, can be added to the litter box to provide privacy for cats and help reduce the spread of dust. The hood can also serve as a base for additional features, such as LED lights, cameras, a fan or air filtration system.

It is specifically designed to fit into the upper edge of the upper bin and securely rest on the upper edge of the litter box without the need for fasteners or clamps. The hood or cover is typically made of PET plastic that is half transparent in a conventional injection mold process.

### LED Light or Light Strips

Optional light emitting diode (LED) lights or light strips can be placed on the hood of the litter box or along the edges of the cat litter box to illuminate the surrounding area, assisting cats with poor vision while also serving as a decorative element.

### Air Filter System

Optional air filter systems can be installed in the hood or other areas of the cat litter box. Such a system may comprise a fan and odor-filtering substances, and may also comprise sensors that detect the activity of a cat, and can be activated a few moments after the cat uses the litter box, drawing air through the system to filter and reduce odors. The system can utilize deodorizing materials or other odor-filtering substances to neutralize the foul smell of fresh cat waste.

### Motion Activated Camera

Optional cameras can be installed in the hood or other areas of the cat litter box. Such a camera is usually motion activated to record pets entering and using the litter box.

### Nail-Filing Panels

Optional nail-filing features can be installed to assist in natural nail maintenance for cats. The feature consists of a small, customizable panel, typically around 1.25×2.5 cm in dimension, made from durable materials such as stainless steel or fiberglass, with a textured surface designed for gentle filing. Such nail filing features may be attached to any wall within the litter box using various methods, including double-sided tape, adhesive glue, or a slotted groove design that allows the file to slide securely into place.

The number and size of these panels can be adjusted to suit each cat's unique scratching habits, providing a tailored solution that naturally grinds and files the cat's nails as they scratch inside the litter box. This addition minimizes the need for manual nail trimming, offering convenience for pet owners while promoting healthy nail maintenance for cats.

With this Application, several embodiments of the invention, including the best mode contemplated by the inventors, have been disclosed. It will be recognized that, while specific embodiments may be presented, elements discussed in detail only for some embodiments may also be applied to others. Such features or combinations are capable of being carried out based on the present specification as a whole in light of the common general knowledge of a person skilled in the art, irrespective of whether such features or combinations of features solve any problems disclosed herein, and without limitation to the scope of the claims. Aspects of the present invention may consist of any such feature or combination of features.

While specific materials, designs, configurations and fabrication steps have been set forth to describe this invention and the preferred embodiments, such descriptions are not intended to be limiting. Modifications and changes may be apparent to those skilled in the art, and it is intended that this invention be limited only by the scope of the appended claims and their equivalents.

1. A multi-layered cat litter box, comprising:
an upper bin comprising:
a plurality of sides; and
a flat bottom,
wherein the flat bottom of the upper bin has (i) a first portion comprising a plurality of apertures, with each of the apertures having its smallest dimension being 5 mm or less, and (ii) a second portion with no apertures; and
a second bin consisting of:
a plurality of sides,
wherein a top portion of the sides of the second bin comprises one or more sections having widths that allow the upper bin to be supported above the second bin by placing the second portion of the flat of the upper bin onto the one or more sections of the top portion of the sides of the second bin; and
a bottom with no apertures,
wherein the sides and the bottom of the second bin are fabricated as a single contiguous structure.

2. The litter box of claim 1, wherein
the sides and the flat bottom of the upper bin are molded from plastic as a single contiguous structure.

3. The litter box of claim 1, wherein
the sides and the bottom of the second bin are molded from plastic.

4. The litter box of claim 1, wherein
the sides and the flat bottom of the upper bin are fabricated using stainless steel.

5. The litter box of claim 1, wherein
the sides and the bottom of the second bin are fabricated using stainless steel.

6. The litter box of claim 1, wherein
the first portion of the flat bottom of the upper bin is detachable.

7. The litter box of claim 6, wherein
the upper bin additionally comprises slots that allow secure placement of the first portion; and
the litter box additionally comprises fasteners that allow secure attachment of the first portion to the upper bin using the slots of the upper bin.

8. (canceled)

9. The litter box of claim 6, wherein
the detachable first portion of the bottom of the upper bin is fabricated from stainless steel.

10. The litter box of claim 1, additionally comprising:
a mesh insert for the upper bin,
wherein the mesh insert comprises apertures with dimensions smaller than the smallest dimension of the plurality of apertures in the upper bin.

11. The litter box of claim 10, wherein
the apertures of the mesh insert have a dimension smaller than 1 mm.

12. The litter box of claim 10, wherein
the mesh insert is fabricated from stainless steel.

13. The litter box of claim 1, wherein
the upper bin and the second bin each have a rounded rectangular shape having a long dimension and a short dimension, with the long dimension of the rounded rectangular shape for each bin being smaller than 60 cm;
the sides of the second bin have a height greater than 2.5 cm; and
the sides of the upper bin have a height greater than the height of the second bin.

14. The litter box of claim 1, wherein
the sides of the upper bin comprise two portions, a back portion and a front portion, each having a height, with the height of the back portion greater than the height of the front portion.

15. The litter box of claim 1, wherein
the sides of the upper bin comprise a rolled-over portion, providing one or more surfaces for lifting the upper bin; and wherein
the one or more sections of the second bin comprise a shelf and a raised edge, with dimensions that allow the upper bin to be supported on the shelf while allowing a position of the upper bin to be restrained by the raised edge.

16. The litter box of claim 1, wherein
the plurality of apertures of the upper bin are rounded rectangular apertures, with a first dimension being 5 mm or smaller, and a second dimension perpendicular to the first dimension being greater than the first dimension and smaller than 30 mm.

17. The litter box of claim 1, additionally comprising:
a hood, attached to the upper bin.

18. (canceled)

19. The litter box of claim 1, additionally comprising:
a support tray, comprising a raised edge that allows position of the second bin to be restrained when placed in the support tray.

20. A multi-layered cat litter box, comprising:
an upper bin comprising:
a plurality of sides; and
a flat bottom, wherein the flat bottom of the upper bin has (i) a first portion comprising a plurality of apertures having dimensions of width and length, with the smallest dimension of the apertures being smaller than any dimension of a pre-selected pellet litter, and (ii) a second portion with no apertures; and
a second bin consisting of:
a plurality of sides,
wherein a top portion of the sides of the second bin comprise one or more lip sections having widths that allow the upper bin to be supported above the second bin by placing the second portion of the flat bottom of the upper bin onto the one or more lip sections; and
a bottom with no apertures,
wherein the sides and the bottom of the second bin are fabricated as a single contiguous structure.

21-23. (canceled)
